(19) United States
(12) Patent Application Publication
(10) Pub. No.: US 2009/0052332 A1
(43) Pub. Date: Feb. 26, 2009

(54) DEVICE, SYSTEM, METHOD AND PROGRAM FOR COLLECTING NETWORK FAULT INFORMATION

(75) Inventors: Noriyuki FUKUYAMA, Kawasaki (JP); Masanobu Morinaga, Kawasaki (JP); Hideaki Miyazaki, Kawasaki (JP); Sumiyo Okada, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/193,393

(22) Filed: Aug. 18, 2008

(30) Foreign Application Priority Data
Aug. 20, 2007 (JP) 2007-213954

(51) Int. Cl. G06F 11/00

(52) U.S. Cl. 370/242

(57) ABSTRACT

A network fault information collecting device arranged in a packet network includes a quality degradation detecting unit which monitors packets to be regularly transmitted and received in the packet network, and detects quality degradation of the packets. The device includes a node search unit which searches for nodes on a path between transmission and reception terminals for the packet, upon detection of the quality degradation of the packets in the quality degradation detecting unit. The device includes an information collecting unit which issues an information collecting packet for each terminal searched by the node search unit, and collects and records terminal information.

### CROSS-REFERENCE TO RELATED APPLICATIONS

This application is related to and claims priority to Japanese patent application No. 2007-213954, filed on Aug. 20, 2007 in the Japan Patent Office, the entire contents of which are incorporated by reference herein.

### BACKGROUND

1. Field

The embodiments discussed herein are directed to a network fault information collecting device, system, method and program for collecting fault information of an IP network, and more particularly to a network fault information collecting device, system, method and program for efficiently collecting fault information including a network fault which has intermittently or temporarily occurred.

2. Description of the Related Art

Conventionally, a monitoring device known as a probe, server or agent is arranged in a network to realize early detection and early repair of an IP (Internet Protocol) network fault. In addition, a test command is issued periodically in a predetermined cycle, network quality information including the traffic, loss rates, or jitters is collected from a network terminal such as a router or gateway, and log information including CPU load is collected from a server connected to the network. Based on these pieces of information, the life/death condition of the network terminal and its operation condition are monitored (Japanese Patent Application Laid-Open No. 7-231325).

In this case, to collect the information from the monitoring device, MIB (Management Information Base) information is acquired using an SNMP (Simple Network Management Protocol), a ping packet in ICMP (Internet Control Message Protocol) is issued, and information is collected by transferring log information (log file) with an FTP (File Transfer Protocol), so as to measure the traffic or CPU load of the network.

According to the conventional method for periodically collecting network quality information, network quality information measured by a node (such as a router or gateway) and log information regarding CPU load and measured by a computer (such as a server connected to the network) are recorded at a predetermined time interval.

Thus, when a network fault occurs intermittently, or when the traffic or load temporarily increases, the value is averaged due to recording at a predetermined time interval, thus overlooking the phenomenon as a factor of the network fault.

If a short measurement interval is set so as to increase the resolution and avoid this problem, it is necessary to access the network terminal frequently. Thus, the processing ability of the node is decreased, causing a large amount of measurement traffic to flow through the network, and influencing the original traffic, resulting in a problem of a trade-off between the measurement accuracy and the processing ability.

As a result, the collection of the network information is delayed when the fault has occurred, and the repair of the fault is delayed as well.

### SUMMARY

It is an aspect of the embodiments discussed herein to provide a network fault information collecting device arranged in a packet network, including a quality degradation detecting unit which monitors packets to be regularly transmitted and received in the packet network and detects quality degradation of the packet, a node search unit which searches for nodes on a path between transmission and reception terminals for the packet, upon detection of the quality degradation of the packets in the quality degradation detecting unit, and an information collecting unit which issues an information collecting packet for each node searched by the nodes search unit, and collects and records nodes information.

In this device, the quality degradation detecting unit monitors audio packets using a VoIP (Voice over Internet Protocol), determines that a delay time of the audio packets increases or that the audio packets are lost, thereby detecting the quality degradation.

The nodes search unit includes at least one of a first nodes search unit and a second nodes search unit. The first nodes search unit searches for an IP address of each node on the path between the transmission and reception terminals by issuing a node search command to the transmission and reception terminals for the packet. The second nodes search unit searches for an IP address of a each node on the path between the transmission and reception terminals based on network topology information registered in advance.

The information collecting unit issues the SNMP command a plurality of times at a predetermined time interval toward each node searched by the node search unit. The information collecting unit obtains traffic flow per unit time based on the number of accumulated packets included in acquired node management information (MIB).

The traffic flow corresponds to the number of packets per unit time. The number of packets per unit time, is obtained by dividing the sum of differences of the numbers of accumulated packets by a value obtained by multiplying a value reduced by 1 from the number of times the command is issued by a predetermined time interval. The sum of differences of the numbers of accumulated packets is included in the time-series node management information of the plurality of node management information acquired by issuing the SNMP commands.

For example, the number of accumulated packets included in the node management information acquired at the time the command is issued for the first time is “2000”. The number of accumulated packets included in the node management information acquired at the time the command is issued for the second time is “3100”. The number of accumulated packets included in the node management information acquired at the time the command is issued for the third time is “4200”. The number of accumulated packets included in the node management information acquired at the time the command is issued for the fourth time is “5000”. In the above case, the difference between the numbers of accumulated packets included in the time-series node management information acquired at the time the command is issued for the first and second times is “1100”. Further, the difference between the numbers of accumulated packets included in the time-series node management information acquired at the time the command is issued for the second and third times is “1100”. The difference between the numbers of accumulated packets included in the time-series node management information acquired at the time the command is issued for the third and fourth times is “800”. As a result, the total sum of the differences is “3000”. The total sum of the differences “3000” is divided by a value obtained by multiplying a value “3” reduced by 1 from the number of times “4” the command is issued by a predetermined time interval (for example 5 seconds), thereby obtaining the traffic flow corresponding to the number of packets per unit time as 200 packets/second.

The quality degradation detecting unit measures a packet transmission/reception interval between a particular server and an arbitrary terminal arranged in the packet network. The quality degradation detecting unit detects degradation of connection quality in the server upon detection of degradation of the packet quality. The information collecting unit collects and records operation information from the server, upon detection of the degradation of the connection quality in the quality degradation detecting unit.

The quality degradation detecting unit measures a packet transmission/reception interval time since transmission of the information request packet from a terminal to a server until reception of a response packet. The quality degradation detecting unit determines that the packet transmission/reception interval time exceeds a predetermined threshold value or Jitters over a predetermined fluctuation width, so as to detect degradation of the connection quality.

The quality degradation detecting unit further monitors a packet transmission/reception interval in relation to a request and a response between the server and an arbitrary terminal. The quality degradation detecting unit determines when the packet transmission/reception interval exceeds a predetermined threshold value or when the packet transmission/reception interval jitters over a predetermined fluctuation width, so as to detect degradation of the connection quality.

The server is a SIP (Session Initiation Protocol) server, and the quality degradation detecting unit measures, as the packet transmission/reception interval, a response time since transmission of a SIP signaling packet to the SIP server until reception of its response packet, so as to detect degradation of the connection quality.

The information collecting unit collects, as the operation information, at least one of CPU load of the server, memory usage or free memory capacity, a free disk space, a disk access count, the number of transmitted or received packets and the number of concurrent connection sessions.

The information collecting unit collects and records operation information including at least one of CPU load, memory usage or free memory capacity, a free disk space or disk access count when an external memory like a hard disk drive is included, the number of transmitted or received packets and the number of concurrent connection sessions, from a node which connects different networks arranged in a packet network and can have a plurality of sessions, upon detection of packet quality degradation in the quality degradation detecting unit.

This node is a gateway or a wireless LAN access point.

The gateway includes not only a PSTN gateway for mutual connection between a PSTN (Public Switched Telephone Network) and an IP telephone network, but also an MCU (Multipoint Conference Unit), proxy and the like.

These together with other aspects and advantages which will be subsequently apparent, reside in the details of construction and operation as more fully hereinafter described and claimed, reference being had to the accompanying drawings forming a part hereof, wherein like numerals refer to like parts throughout.

### BRIEF DESCRIPTION OF THE DRAWINGS

FIG. 1 illustrates an explanatory diagram showing a network including a network fault information collecting device of this embodiment;

FIG. 2 illustrates a block diagram showing an embodiment of the network fault information collecting device of this embodiment;

FIG. 3 illustrates a block diagram showing a hardware environment of a computer for realizing the functional configuration of this embodiment;

FIG. 4A-4C illustrate flowcharts each showing a process for collecting network fault information according to the embodiment shown in FIG. 2;

FIG. 5 illustrates a flowchart specifically showing a node search process in operation S3 shown in FIG. 4A;

FIG. 6 illustrates a flowchart specifically showing a router information collecting process in operation S4 shown in FIG. 4A;

FIG. 7 illustrates a flowchart specifically showing a server information collecting process in operation S3 shown in FIG. 4B;

FIG. 8 illustrates a flowchart specifically showing a gateway information collecting process in operation S8 shown in FIG. 4C;

FIG. 9 illustrates an explanatory diagram showing a network fault information collecting system of this embodiment which separately includes a management server and a monitoring device;

FIG. 10 illustrates a block diagram showing embodiments of the monitoring device and the management server shown in FIG. 9;

FIGS. 11A and 11B illustrate flowcharts each showing a process to be performed by the monitoring device shown in FIG. 10;

FIG. 12A-12D illustrate flowcharts each showing a process to be performed by the management server shown in FIG. 10;

FIG. 13 illustrates a flowchart specifically showing a server information collecting process in operation S2 shown in FIG. 12C; and

FIG. 14 illustrates an explanatory diagram showing a network fault information collecting system of this embodiment including a wireless LAN access point as a target for collecting information.

### DETAILED DESCRIPTION OF THE PREFERRED EMBODIMENTS

Reference may now be made in detail to embodiments of the present invention, examples of which are illustrated in the accompanying drawings, wherein like reference numerals refer to like elements throughout.

System

It is an aspect of the embodiments discussed herein to provide a network fault information collecting system including one or a plurality of monitoring devices arranged in a packet network and a management server which manages the one or the plurality of monitoring devices. The monitoring device includes a quality degradation detecting unit which monitors packets regularly transmitted and received in the packet network and detects quality degradation of the packet. The management server includes a nodes search unit which searches for nodes on a path between transmission and reception terminals for the packet upon detection of the quality degradation of the packets in the quality degradation detecting unit. An information collecting unit issues an information collecting packet toward each node searched by the nodes search unit, and collects and records node information.

The information collecting unit of the management server issues an information collecting packet to each node of a plurality of paths which has received detection notification indicating quality degradation from the plurality of monitoring devices, so as to discriminate the same node on the plurality of paths and issue one information collecting command, thereby avoiding duplicate collection of node information.

The quality degradation detecting unit of the monitoring device further measures a packet transmission/reception interval time between a particular server and an arbitrary terminal arranged in the packet network and detects degradation of connection quality in the server, upon detection of degradation of the packets. The information collecting unit of the management server collects and records operation information from the server upon detection of degradation of the connection quality in the quality degradation detecting unit.

The information collecting unit of the management server collects and records operation information including at least one of CPU load, memory usage or free memory capacity, a free disk space or disk access count when an external memory like a hard disk drive is included, the number of transmitted or received packets and the number of concurrent connection sessions, from a device which can concurrently have a plurality of sessions arranged in the packet network, upon detection of the packet quality degradation in the quality degradation detecting unit of the monitoring device.

In this case, the information collecting unit of the management server collects and records the operation information while avoiding its duplication from the gateway and the access point, upon detection of quality degradation of the packet in the plurality of monitoring devices.

Method

It is an aspect of the embodiments discussed herein to provide a network fault information collecting method for use in a network fault information collecting device arranged in a packet network. The method includes a quality degradation detecting operation of monitoring packets which is regularly transmitted and received in a packet communication network and detecting quality degradation of the packet. The method also includes a node search operation of searching for nodes on a path between transmission and reception terminals of the packet upon detection of the quality degradation of the packets in the quality degradation detecting operation. The method also includes an information collecting operation of collecting and recording node information by issuing a test command to each node searched in the node search operation.

Program

It is an aspect of the embodiments discussed herein to provide a network fault information collecting program. The program causes a computer of a network fault information collecting device arranged in a packet network to function as a quality degradation detecting unit which monitors packets regularly transmitted and received in the packet network and detects quality degradation of the packet. A node search unit searches for nodes on a path between transmission and reception terminals for the packet upon detection of the quality degradation of the packets in the quality degradation detecting unit. An information collecting unit issues an information collecting packet toward each node searched by the node search unit, and collects and records node information.

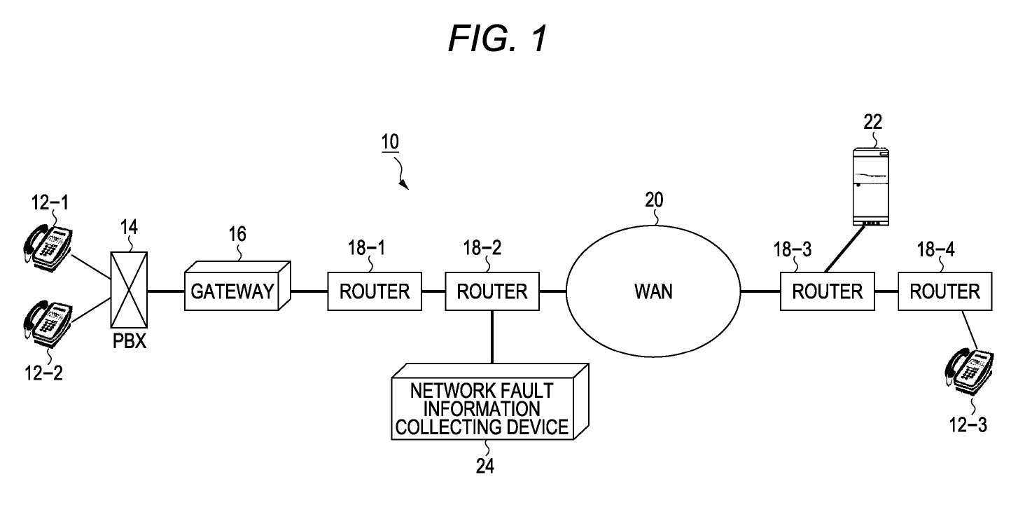

FIG. 1 illustrates an explanatory diagram showing a network including a network fault information collecting device of an example embodiment.

In FIG. 1, in this embodiment, an IP network 10 is a target packet network. In the IP network 10, telephone terminals 12-1 to 12-2 are connected through a gateway 16 and a PBX 14. An IP telephone terminal 12-3 is further connected thereto, and communication is performed with audio packets on an interface protocol using a VoIP.

In the IP network 10, needless to say, packet transmission of data is concurrently performed using an ordinary IP protocol.

The gateway 16, routers 18-1 and 18-2, a WAN (Wide Area Network) 20, and routers 18-3 and 18-4 are arranged on the IP network 10 between the telephone terminals 12-1 and 12-2 on one side of the network and the IP telephone terminal 12-3 on the other side thereof.

After the telephone terminals 12-1 and 12-2 are switched by the PBX 14, they are connected to the IP network 10 through protocol conversion by the gateway 16. The IP telephone terminal 12-3 is directly connected to the IP network 10 through the router 18-4.

A call control server 22 is connected to the router 18-3 for performing telephone call control on the IP network 10 using a VoIP. The call control server 22 is known as a SIP server, corresponding to a SIP (Session Initiation Protocol).

A network fault information collecting device 24 is connected to the IP network 10 through the router 18-2. The IP network 10 carries traffic of audio packets (VoIP packet) for the IP telephone terminal using, for example, VoIP.

The network fault information collecting device 24 monitors the audio packets transmitted or received to or from the gateway 16 and the telephone terminal 12-3 of the IP network 10. Upon detection of quality degradation of the audio packets, in the case of telephonic communication between the gateway 16 and the telephone terminal 12-3 as transmission and reception terminals with respect to the network fault information collecting device 24, the device 24 measures the traffic flow per second of, for example, the routers 18-1 to 18-4 (hereinafter referred to simply as “traffic flow”) as the nodes on the network between the both sides. Further, the device 24 collects and records this information as router information, and can analyze whether congestion fault occurs in the network during the transmission and reception, based on the recorded traffic flow of the routers.

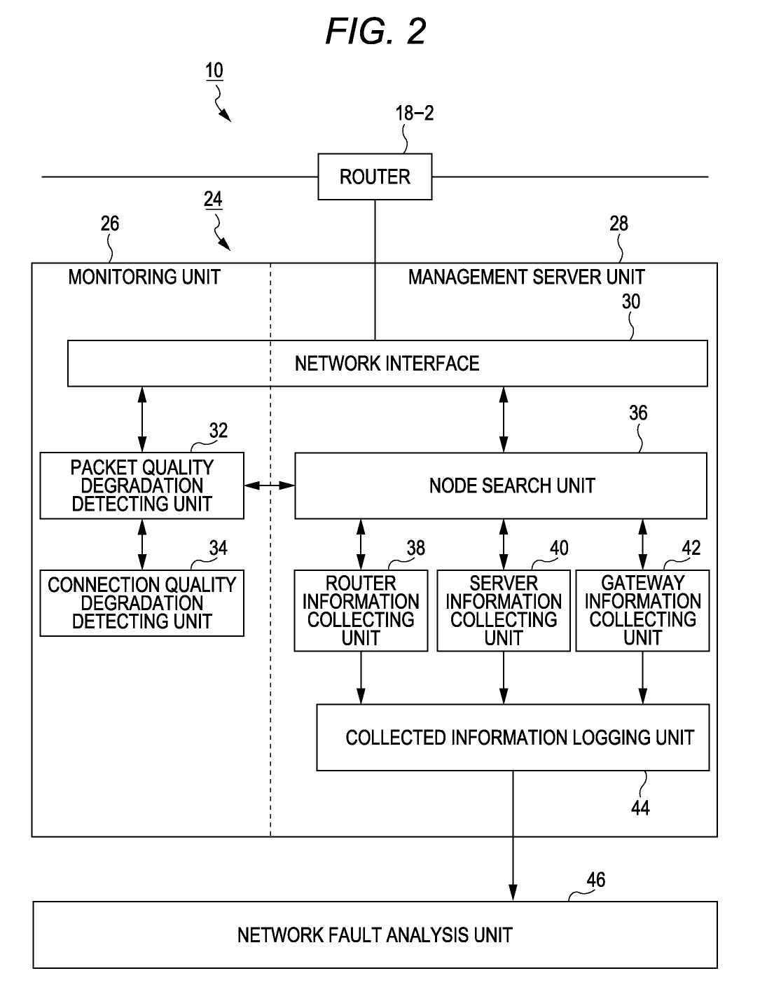

FIG. 2 is a block diagram showing an embodiment of the network fault information collecting device 24 provided in the network of FIG. 1.

In FIG. 2, the network fault information collecting device 24 of this embodiment includes a monitoring unit 26 as a probe and a management server unit 28.

A network interface 30 is commonly provided in the monitoring unit 26 and the management server unit 28.

A packet quality degradation detecting unit 32 and a connection quality degradation detecting unit 34 are provided on the side of the monitoring unit 26.

The packet quality degradation detecting unit 32 monitors an audio packet, using the VoIP, which is regularly transmitted and received in the IP network 10 shown in FIG. 1. The packet quality degradation detecting unit 32 detects the quality degradation of the audio packets, and outputs the detected information to the side of the management server unit 28.

To detect the quality degradation, the packet quality degradation detecting unit 32 detects an increase in a delay time of the VoIP audio packet or a number of audio packets lost (packet loss).

That is, IP telephone audio packets or video streams are trafficked that are very sensitive to a fault occurring in the IP network or when the traffic temporarily increases.

Audio packets are transmitted at intervals of about 20 ms from one IP telephone terminal to the other IP telephone terminal using, for example, the VoIP protocol. The packets are sensitive to the temporary occurrence of the network fault and traffic increase, resulting in an increase in the delay time of the audio packet, audio packet loss, etc.

In this embodiment, the audio packets are monitored so as to detect the quality degradation thereof.

In this embodiment, the audio packets are monitored. However, the video stream packet may be monitored.

Descriptions will later be made on the connection quality degradation detecting unit 34 provided in the monitoring unit 26.

A node search unit 36 provided in the management server unit 28 searches for an IP address of each node (for example, a router, hub, switching hub or the like) on the path in a range between the transmission and reception terminals transmitting and receiving the degradation-detected audio packet on the IP network 10, upon reception of degradation detection notification regarding the audio packet by the packet quality degradation detecting unit 32 of the monitoring unit 26.

Upon detection of the quality degradation of the audio packets transmitted and received, for example, between the gateway 16 and the IP telephone terminal 12-3 of FIG. 1, the node search unit 36 searches for each node on the path in a range from the router 18-2 connected to the network fault information collecting device 24 to the gateway 16 on the transmission side and each node on the path in a range from the router 18-2 to the IP telephone terminal 12-3 on the reception side.

The search process by this node search unit 36 corresponds to a process performed by either the following first node search unit or the second node search unit. In the process performed by the first node search unit, the unit transmits a plurality of packets, for example, to the gateway 16 and the IP telephone terminal 12-3 as transmission and reception terminals while incrementing a TTL (Time To Live) parameter of an ICMP packet by 1. This ICMP packet is used generally in a “tracert (trace route)” command as a node search packet.

The TTL is reduced by 1 every time it passes the router. When the TTL reaches “0”, an ICMP error packet is returned. Thus, the IP address is determined in the path on its way.

For example, if the router 18-2 side transmits a node search packet to the gateway 16 on the transmission side, when the TTL is 1, the router 18-2 returns its own IP address, and when the TTL is 2, the router 18-1 returns its own IP address. This results in that the TTL will be 0.

Similarly, when the router 18-2 transmits a node search packet to the IP telephone terminal 12-3 on the reception side, each of the routers 18-3 and 18-4 returns the IP address.

Thus, even if there is no topology information representing a connection state of the IP network 10 in the network fault information collecting device 24, it is possible to acquire node information including an IP address of the router or gateway on the path.

The second node search unit performs a process in which topology information regarding the network is registered in advance in the network fault information collecting device 24.

In this case, the gateway 16 and the IP telephone terminal 12-3 as the transmission and reception terminals refer to the topology information, thereby acquiring the IP address of each of the routers 18-1 to 18-4 existing on the path connecting the gateway 16 and the IP telephone terminal 12-3, as node information.

A router information collecting unit 38 provided in the management server unit 28 shown in FIG. 2 measures the traffic flows of the respective routers 18-1 to 18-4 existing on the path between the gateway 16 and the telephone terminal 12-3. The unit 38 collects the measured information as router information, and records the information in a collected information logging unit 44. Note that the gateway 16 and the telephone terminal 12-3 are examples of the transmission and reception terminals for the quality-degraded audio packet acquired by the node search unit 36.

To measure the traffic flows of the routers 18-1 to 18-4, the router information collecting unit 38 issues an SNMP packet (also called an SNMP command packet) a plurality of times at a predetermined interval of approximately a few seconds to the router specified with the IP address, acquires management information called “MIB (Management Information Base)” returned from the router as reply information of the SNMP packet, and acquires the number of accumulated packets included in the MIB so as to obtain the traffic flows.

Specifically, the router information collecting unit 38 functions as an SNMP manager, and the router side functions as an SNMP agent, thereby returning the MIB in response to the SNMP packet.

For the number of accumulated packets obtained from the MIBs corresponding to an “N” number of times and acquired using the SNMP packets, the traffic flow is obtained as follows:

For example, when T=5 sec and the total numbers (N1, N2, N3, N4) of packets are acquired for an n=4 number of times, the traffic flow as the number of packets per second can be obtained using the following equation.

Traffic flow={(N2−N1)+(N3−N2)+(N4−N3)}/[(n−1)×T]

Based on this equation for the traffic flow, the sum of differences of adjacent packet total numbers is divided by a value obtained by multiplying a value, obtained by subtracting 1 from the acquired number (i.e., “n−1”), by the command issuing interval, 5 seconds.

The traffic flows are measured sequentially for the four routers 18-1, 18-2, 18-3 and 18-4 existing on the path of the transmission and reception terminals of FIG. 1. The measured traffic flows are collected as router information and recorded in the collected information logging unit 44.

The traffic flow of each of the routers that is recorded in the collected information logging unit 44 is transmitted, for example, to an external network fault analysis unit 46. The network fault analysis unit 46 can accurately analyze and know whether a network congestion fault occurs based on the traffic flows of the routers as the collected router information.

A server information collecting unit 40 provided in the management server unit 28 collects and records operation information from a specified server (for example, the call control server 22 shown in FIG. 1), in cooperation with the connection quality degradation detecting unit 34 provided in the monitoring unit 26.

The connection quality degradation detecting unit 34 provided in the monitoring unit 26 cooperating with the server information collecting unit 40 measures the transmission time of a SIP signaling packet transmitted from the gateway 16 to the call control server 22 and measures also the packet transmission/reception interval time until reception of a reply packet, so as to detect degradation of connection quality in the call control server 22.

The connection quality degradation detecting unit 34 may transmit a SIP signaling packet to the call control server 22 through a network interface from the monitoring unit 26, measure the packet transmission/reception interval time until reception of its corresponding reply packet, and detect degradation of connection quality in the call control server 22.

The call control server 22 known as a SIP server has a service function for returning an IP address of a communication (inquiry) target, upon inquiry of the server using a SIP signaling packet specifying its IP address.

The unit measures, as a packet transmission/reception interval time, the time since transmission of the SIP signaling packet until return and reception of a reply packet representing the communication target IP address.

If the CPU load temporarily increases in the call control server 22, and upon reception of SIP signaling packets from a plurality of IP telephone terminals, the number of concurrent connection sessions increases. As a result, the packet transmission/reception interval time in the call control server 22 may temporarily increase. In the worst case, no reply can be transmitted.

The connection quality degradation detecting unit 34 detects the degradation of the connection quality in the call control server 22 and informs the management server unit 28 about it, when the packet transmission/reception interval time which has been measured in the specified call control server 22 using the SIP signaling packet exceeds a predetermined threshold value, or when it is determined that the packet transmission/reception interval jitters over a predetermined fluctuation width.

The management server information collecting unit 40 specifies an IP address of the call control server 22 upon reception of degradation notification regarding the connection quality of the call control server 22 that is specified by the connection quality degradation detecting unit 34. The management server information collecting unit 40 collects, as server operation information, at least one of the CPU load, the memory usage or free memory capacity, the free disk space, the disk access count, the number of transmitted or received packets, and the number of concurrent connection sessions. Then, the unit 40 records the collected information in the collected information logging unit 44.

The unit outputs at least one of the operation information of the call control server 22 specified by the server information collecting unit 40, to the network fault analysis unit 46, thus enabling the network fault analysis unit 46 to know whether the SIP server is in an abnormal load condition as an analysis result. Note that the operation information is recorded in the collected information logging unit 44 and includes the CPU load (CPU usage), the memory usage or free memory capacity, the free disk capacity, the disk access count, the number of transmitted or received packets, and the number of concurrent connection sessions.

Further, a gateway information collecting unit 42 provided in the management server unit 28 operates in the packet quality degradation detecting unit 32 provided in the monitoring unit 26, upon reception of degradation detection notification regarding the audio packet on the path of the network transmission/reception terminals between the gateway 16 and the IP telephone terminal 12-3 shown in FIG. 1. The unit 42 specifies the IP address of the gateway 16 searched by the node search unit 36 on the path. Like the case of the call control server 22 by the server information collecting unit 40, the unit 42 collects, as gateway operation information, the CPU load in the gateway 16, the memory usage or free memory capacity, the free disk space or disk access count when any external memory like a hard disk drive is included, the number of transmitted or received packets, and the number of concurrent connection sessions. The unit 42 records the collected information in the collected information logging unit 44.

The gateway operation information recorded in the collected information logging unit 44 is read out and analyzed by the network fault analysis unit 46, thereby enabling to know an analysis result indicating whether the gateway 16 is in an abnormal load condition.

In the embodiment of FIG. 2, the call control server 22 of FIG. 1 is exemplified as a target from which information is collected by the server information collecting unit 40. However, other than that, any appropriate server, such as a Web server may be a target server from which corresponding information is returned in response to an external information request packet connected to the IP network 10.

Other than for the gateway, for each unit (e.g. a proxy server) available for a plurality of concurrent call sessions, the unit 42 can acquire at least one of the CPU load, the memory usage or free memory capacity, the free disk space or disk access count when an external memory like a hard disk drive is included, the number of transmitted or received packets, and the number of concurrent connection sessions. Then, the unit 42 can record the acquired information as collected information.

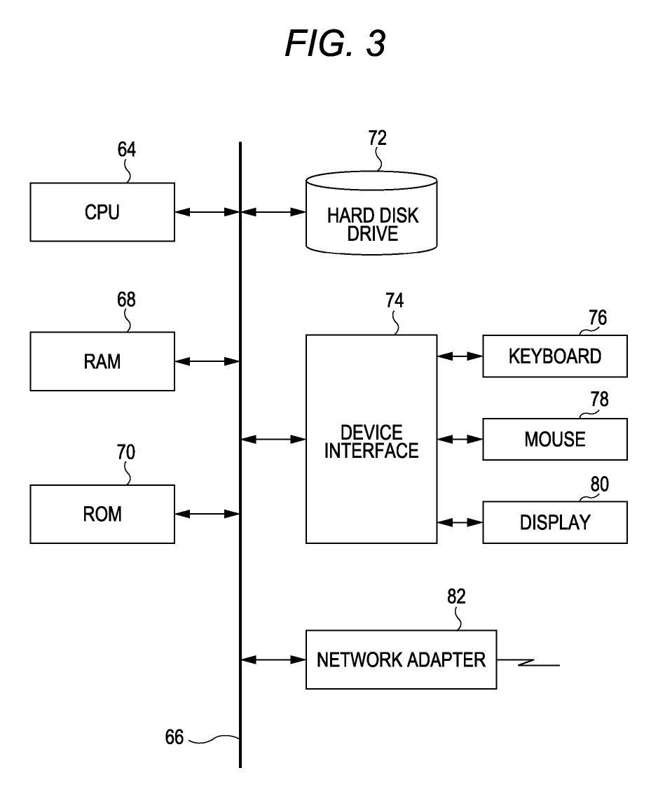

FIG. 3 is a block diagram showing a hardware environment of a computer for realizing the functions of the network fault information collecting device of this embodiment.

In FIG. 3, the computer including the network fault information collecting device 24 of this embodiment has a CPU 64, and has also a RAM 68, a ROM 70, a hard disk drive 72, a keyboard 76, a mouse 78, a device interface 74 connected to a display 80, and a network adapter 82 which are connected to a bus 66 for the CPU 64.

The keyboard 76, the mouse 78 and the display 80 are not always necessary, and can selectively be provided as needed.

The hard disk drive 72 stores, as an application program, a program for realizing each function of the monitoring unit 26 and management server unit 28 shown in FIG. 2.

Upon activation of the computer, the OS is loaded from the hard disk drive 27 into the RAM 68 so as to be executed, after performing an initialization diagnostic process by execution of the boot code of the ROM 70.

Upon execution of the OS, an application program functioning as the network fault information collecting device of this embodiment is loaded into the RAM 68 from the hard disk drive 72, so as to be executed by the CPU 64.

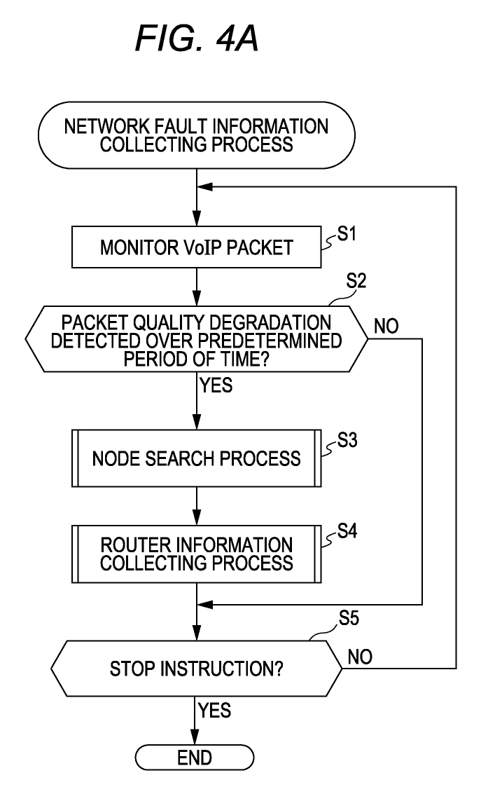

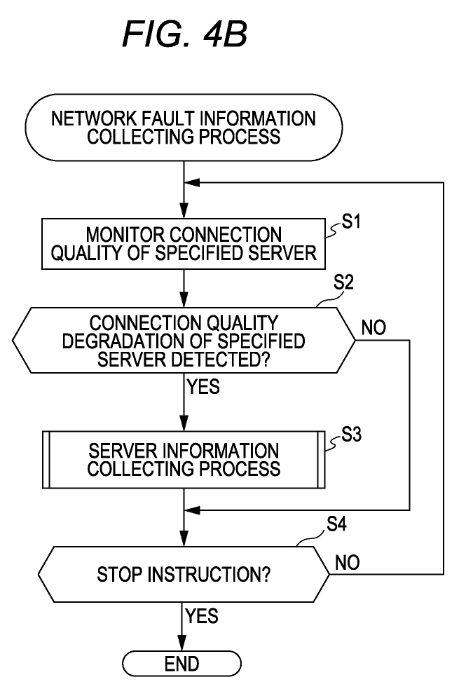

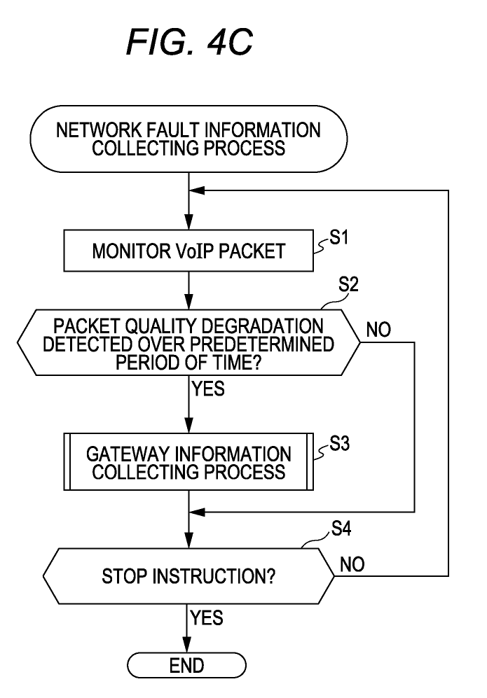

FIGS. 4A, 4B and 4C are flowcharts each showing a network fault information collecting process of this embodiment shown in FIG. 2, and will more specifically be descried below with reference to FIG. 1 and FIG. 2.

FIG. 4A is a flowchart showing the network fault information collecting process for collecting router information.

In FIG. 4A, in the network fault information collecting process of this embodiment, an audio packet of VoIP on the IP network 10 is monitored by the packet quality degradation detecting unit 32 provided in the monitoring unit 26 in operation S1.

Upon detection of packet quality degradation for a predetermined period of time, for example, a few seconds in the above monitoring of operation S2, the process proceeds to operation S3. Then, the router information collecting unit 38 provided in the management server unit 28 measures and records the traffic flows, as router information, for the routers 18-1 to 18-4 existing on the path connecting the transmission/reception terminals, for example, the gateway 16 and the telephone terminal 12-3.

The above processes S1 to S4 are repeated until reception of a stop instruction in operation S5.

FIG. 4B is a flowchart showing a network fault information collecting process for collecting server information.

In FIG. 4B, the connection quality degradation detecting unit 34 provided in the monitoring unit 26 of FIG. 2 monitors the connection quality of the call control server 22 as a specified server in operation S1. The process proceeds to operation S3 Upon determination of the detected connection quality degradation in operation S2. The server information collecting unit 40 collects and records, as server information, server operation information representing the CPU load of the specified call control server 22, the memory usage or free memory capacity, the free disk space, the disk access count, the number of transmitted or received packets and the number of concurrent sessions.

The above-described processes of operation S1 to S3 are repeated until reception of a stop instruction in operation S4.

FIG. 4C is a flowchart showing a network fault information collecting process for collecting gateway information.

In FIG. 4C, the packet quality degradation detecting unit 32 provided in the monitoring unit 26 monitors an audio packet of VoIP on the IP network 10 in operation S1.

Upon detection of the packet quality degradation for a predetermined period of time, for example, a few seconds during the monitoring in operation S2, the unit collects and records, as gateway operation information, representing the CPU load for the gateway 16, the memory usage or free memory capacity, the free disk space or disk access count when an external memory such as a hard disk drive is included, the number of transmitted or received packets and the number of concurrent connection sessions, in operation S3.

The above-described processes of operations S1 to S3 will be repeated until reception of a stop instruction in operation S4.

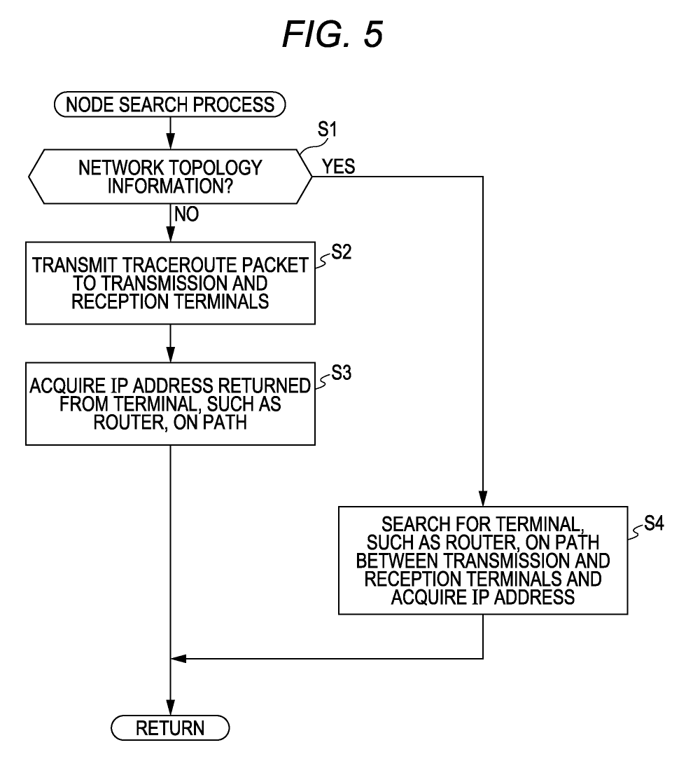

FIG. 5 is a flowchart specifically showing a node information collecting process in operation S3 of FIG. 4.

The node information collecting process of FIG. 5 is performed by the node search unit 36 provided in the management server unit 28 of FIG. 2.

In operation S1, the node search unit 36 checks whether network topology information about the IP network 10 of FIG. 1 exists.

If such topology information does not exist, a trace route packet is transmitted to the transmission and reception terminals in operation S2 (S2 in FIG. 5). As a result, the unit searches the terminals, such as the routers 18-1 to 18-4 and the gateway 16 on the path between the gateway 16 and the telephone terminal 12-3, so as to acquire their IP addresses (S3 in FIG. 5).

Specifically, the network fault information collecting device 24 transmits a node search packet to the gateway 16 on the transmission side and the IP telephone terminal 12-3 on the reception side, through the router 18-2. At the point when the TTL (Time to Live) of the node search packet in each terminal reaches 0, its IP address is returned. The returned IP address is acquired in operation S3, thus obtaining the search result as network terminal information.

On the other hand, if such topology information about the network exists in operation S1, the unit 36 searches the topology information for and acquire the IP addresses of the routers 18-1 to 18-4 existing on the path between the gateway 16 and the IP telephone terminal 12-3 as the transmission and reception terminals in operation S4.

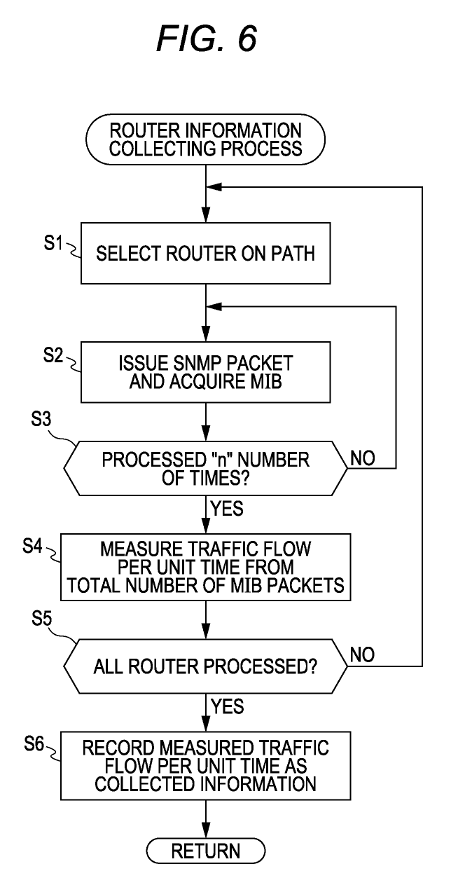

FIG. 6 is a flowchart specifically showing the router information collecting process in operation S4 of FIG. 4.

The router information collecting process of FIG. 6 is executed by the router information collecting unit 38 provided in the management server unit 28 of FIG. 2.

In operation S1, the unit 38 selects one of the routers 18-1 to 18-4, for example, the router 18-1, of FIG. 1 on the path that are searched by the node search unit 36. Then, the unit 38 issues an SNMP packet in operation S2, and acquires an MIB from the router 18-1.

Subsequently, the unit 38 checks whether the process has been performed a predetermined “n” number of times in operation S3. When the process has not been performed the predetermined “n” number of times, the unit 38 waits for a predetermined period of time, for example, 5 seconds or so, issues a next SNMP packet and acquires an MIB in operation S2.

When it is determined in operation S3 that the process has been completed “n” number of times, the process proceeds to operation S4. The unit 38 acquires the total number of packets from the acquired MIBs corresponding to the “n” number of times, divides the sum of differences of adjacent packet total numbers by a value obtained by multiplying the time interval of issuing the SNMP command by a value obtained by subtracting 1 from the “n” number of times, so as to measure the traffic flow per second.

Subsequently, the unit 38 checks whether all routers have been processed in operation S5. If the process has not been completed for all routers, the process proceeds to operation S1. The unit 38 then selects the next router and repeats the same processes.

When it is determined that all routers have been processed in operation S5, the unit 38 records, as collected information, the measured traffic flow per unit time with respect to each of the above routers in operation S6.

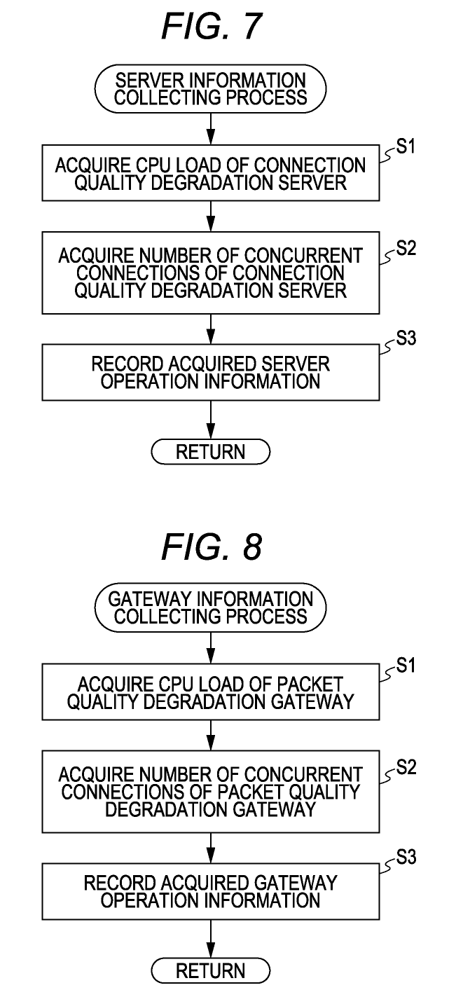

FIG. 7 is a flowchart specifically showing the server information collecting process in operation S5 of FIG. 4.

The server information collecting process of FIG. 7 is executed by the server information collecting unit 40 of FIG. 2 in cooperation with the connection quality degradation detecting unit 34 provided in the monitoring unit 26.

As shown in operations S5 and S6 in the flowchart of FIG. 4, in the process of the connection quality degradation detecting unit 34, the unit measures the packet transmission/reception interval since transmission of a SIP signaling packet to a specified call control server 22 until reception of its reply packet. When the packet transmission/reception interval exceeds a predetermined threshold value, or when the packet transmission/reception interval jitters over a predetermined fluctuation width, the unit detects the connection quality degradation of the specified call control server 22, and executes the server information collecting process of FIG. 7.

In the server information collecting process of FIG. 7, in operation S1, the unit acquires the CPU load of the specified connection quality degraded server, i.e. the CPU load of the call control server 22.

Subsequently, in operation S2, the unit acquires the number of concurrent connection sessions of the call control server 22 as the connection quality degraded server.

In operation S3, the unit records at least one of the acquired server operation information items, of the CPU load, the memory usage or free memory capacity, the free disk space, the disk access count, the number of transmitted or received packets, and the number of concurrent connection sessions.

FIG. 8 is a flowchart specifically showing the gateway information collecting process in operation S8 of FIG. 4.

In FIG. 8, the gateway information collecting process is executed by the gateway information collecting unit 42 provided in the management server unit 28 of FIG. 2.

The unit 42 acquires the CPU load from the gateway 16 existing on the transmission/reception path wherein degradation has been detected by the packet quality degradation detecting unit 32 in operation S1.

Subsequently, in operation S2, the unit 42 acquires the number of concurrent connection sessions from the same gateway 16.

Though not shown in any of operations, the unit acquires the operation information, such as the memory usage or free memory capacity, the free disk space or disk access count when an external memory like a hard disk drive is included, and the number of transmitted or received packets.

In operation S3, the unit records the CPU load and the number of concurrent connection sessions, as the acquired gateway operation information.

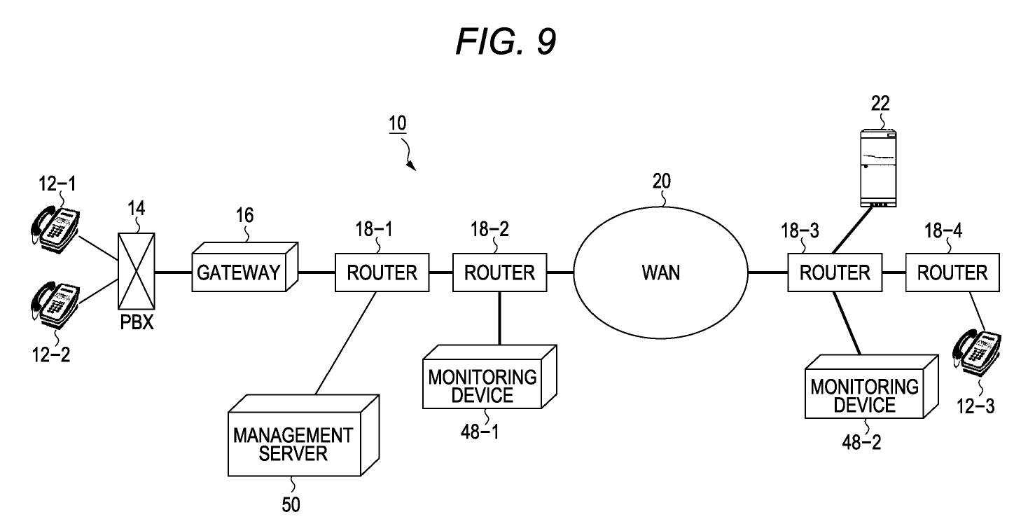

FIG. 9 is an explanatory diagram of a network fault information collecting system separately including a monitoring device and a management server.

In FIG. 9, the IP network 10 is the same as that of FIG. 1. In this embodiment, monitoring devices 48-1 and 48-2 are connected to the IP network 10 through the routers 18-2 and 18-2.

A management server 50 is connected thereto through the router 18-1.

The management server 50 manages the monitoring devices 48-1 and 48-2.

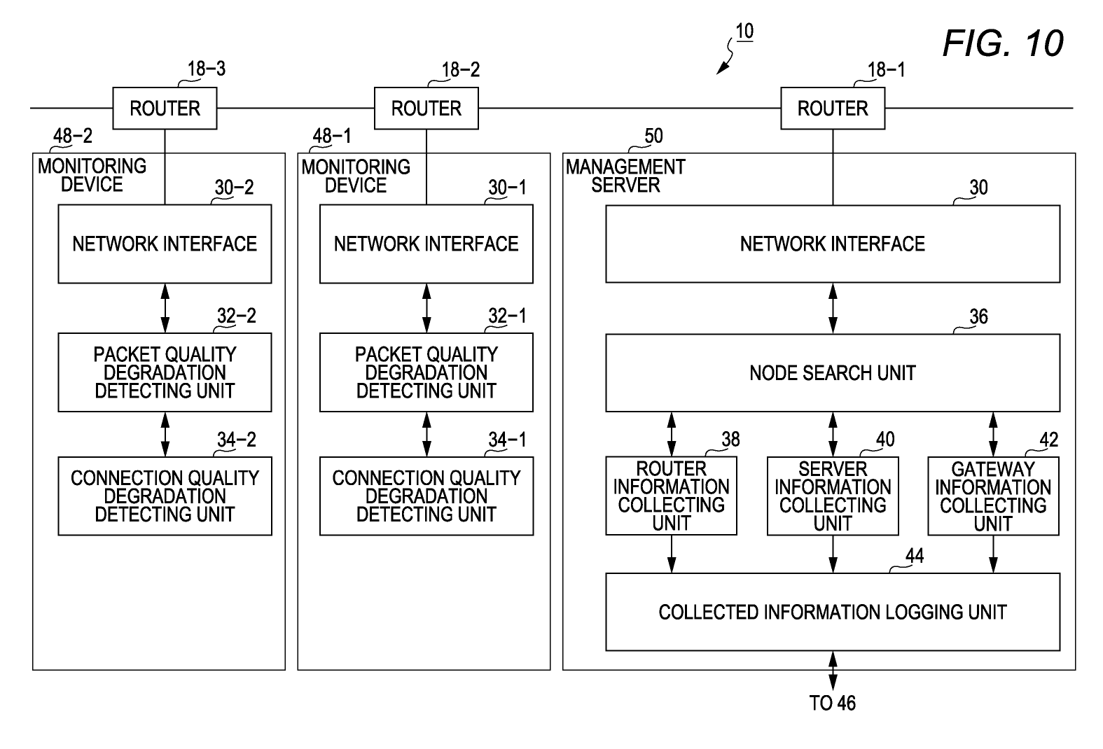

FIG. 10 is a block diagram showing the embodiment of the monitoring devices and the management server of FIG. 9.

In FIG. 10, the monitoring device 48-1 includes a network interface 38-1, a packet quality degradation detecting unit 32-1 and a connection quality degradation detecting unit 34-1.

The packet quality degradation detecting unit 32-1 and the connection quality degradation detecting unit 34-1 provided in the monitoring device 48-1 have the same functions as those of the packet quality degradation detecting unit 32 and the connection quality degradation detecting unit 34 shown in the embodiment of FIG. 2.

The monitoring device 48-2 connected to the IP network 10 through the router 18-3 also has a network interface 30-2, a packet quality degradation detecting unit 32-2 and a connection quality degradation detecting unit 34-2, whose functions are the same as those units included in the monitoring device 48-1.

The management server 50 managing the monitoring devices 48-1 and 48-2 includes the network interface 30, the node search unit 36, the router information collecting unit 38, the server information collecting unit 40, the gateway information collecting unit 42 and the collected information logging unit 44, and thus has the same configuration as that of the management server 28 of FIG. 2.

In the embodiment of FIG. 9 and FIG. 10, the plurality of monitoring devices 48-1 and 48-2 are arranged in different positions on the path of the IP network 10. The plurality of monitoring devices 48-1 and 48-2 detects the degradation of the audio packet in the VoIP and the degradation of the connection quality in a specified server (e.g. the call control server 22) after detection of the packet degradation, and inform the detection result to the management server 50. The management server 50 collects router information, server information and gateway information, in response to network congestion or server abnormal load.

The management server 50 of FIG. 10 may receive degradation detection information of the audio packet concurrently from the plurality of monitoring devices 48-1 and 48-2 arranged in the IP network 10.

In this case, the node search unit 36 searches for the corresponding node, such as the router or gateway, existing on the path between the network transmission and reception terminals, in association with each packet degradation detection. Before collecting duplicate information regarding the same node from the node search results of the plurality of paths, the unit detects the duplicate node so as to perform a process for avoiding duplicate measurements.

Specifically, the node search unit 36 can acquire the IP address of a network terminal for each path wherein the packet quality degradation has been detected. Thus, when the same IP address is found in different paths, the unit merges the repeated IP addresses into a single IP address, thereafter collecting the information so as to avoid collection of duplicate information.

Other than above, the same functions are realized as those of FIG. 2 wherein the monitoring unit 26 and the management server unit 28 are incorporated together.

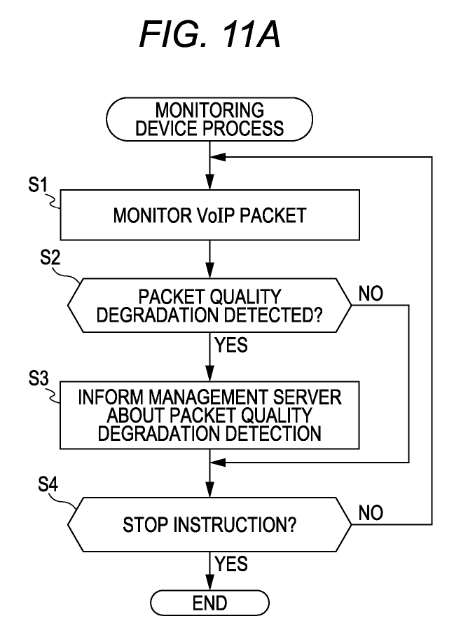

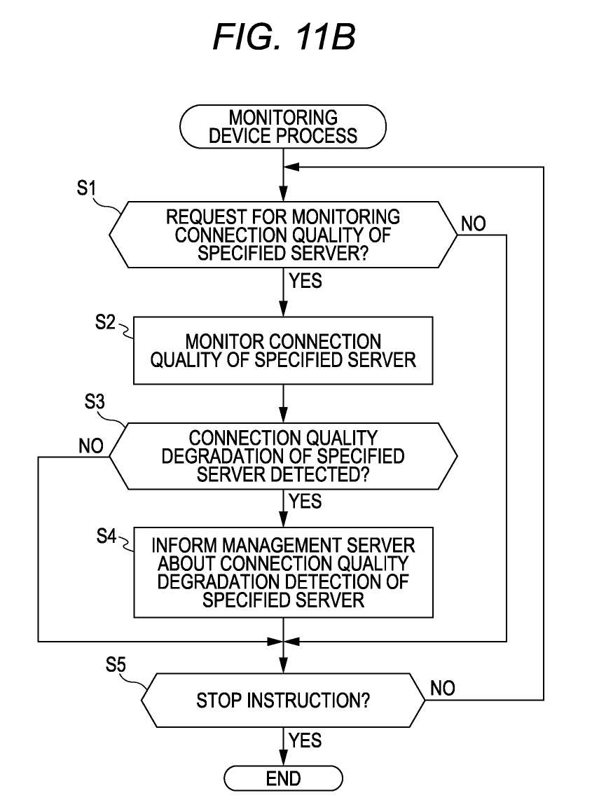

FIGS. 11A and 11B are flowcharts each showing a process to be performed by the monitoring devices 48-1 and 48-2 in the embodiment of FIG. 10.

FIG. 11A is a flowchart showing a process of the monitoring device for detecting the packet quality degradation.

In FIG. 11A, in the example of the monitoring device 48-1 of FIG. 10, the packet quality degradation detecting unit 32-1 provided in the monitoring device 48-1 monitors a delay time and packet loss of the audio packet using the VoIP in operation S1.

When the delay time of the audio packet increases beyond a predetermined value or the packet loss occurs during the monitoring, the unit detects the packet quality degradation in operation S2, and informs the packet quality degradation detection to the management server 50 in operation S3.

The above processes of operations S1 to S3 are repeated until reception of a stop instruction in operation S4.

FIG. 11B is a flowchart showing a process to be performed by the monitoring device, for detecting the server connection quality degradation.

In FIG. 11B, in the example of the monitoring device 48-1 of FIG. 10, the process proceeds to operation S2 upon determination of a connection quality monitoring request for a specified server (e.g. the call control server 22 of FIG. 9) from the management server 50 in operation S1. The connection quality degradation detecting unit 34-1 of the monitoring device 48-1 then monitors the connection quality of the call control server 22, as the specified server.

Specifically, the unit transmits a SIP signaling packet to the call control server. When the packet reception interval until reception of its reply packet exceeds a predetermined value, or when the packet reception interval jitters over a predetermined fluctuation width, the unit detects the connection quality degradation. When this degradation is detected in operation S3, the process proceeds to operation S4, and the unit informs the management server 50 of the connection quality degradation detection regarding the call control server 22 as the specified server.

The above-described processes of operations S1 to S4 are repeated until reception of a stop instruction in operation S5.

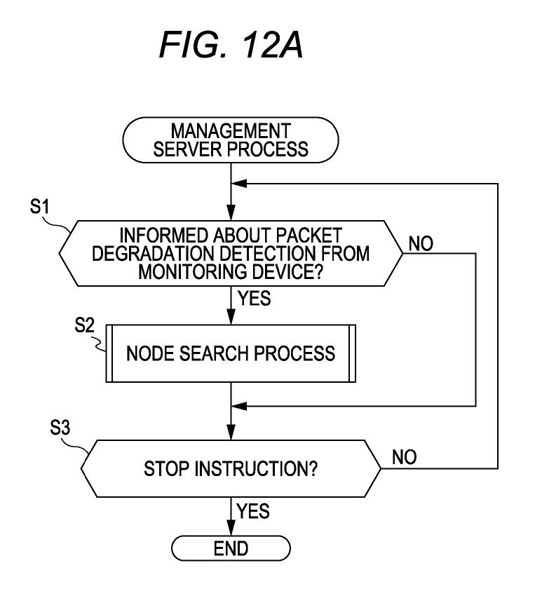

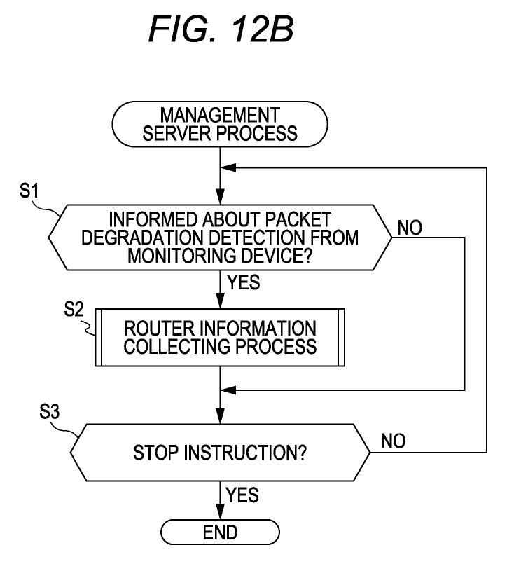

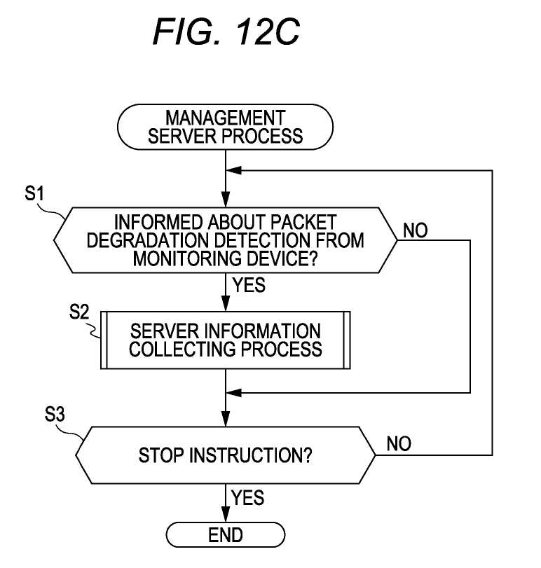

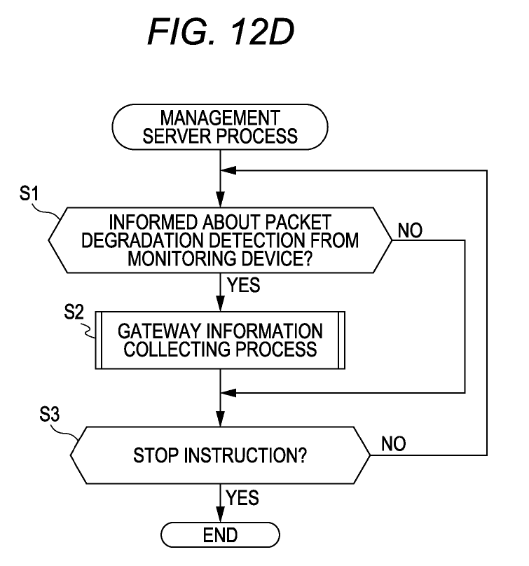

FIGS. 12A, 12B, 12C and 12D are flowcharts each showing a management server process by the management server 50 of FIG. 10. As shown in FIGS. 12A, 12B, 12C and 12D, a node search process, a router information collecting process, a server information collecting process and a gateway information collecting process are independently performed.

In the management server process in FIG. 12A, the management server 50 checks whether packet degradation detection information has been transmitted from the monitoring device 48-1 or 48-2 in operation S1 (S1 of FIG. 12A). When it is determined that the packet degradation detection information has been transmitted, the process proceeds to operation S2, and the node search unit 36 executes the node search process (S2 of FIG. 12A).

The above-described processes of operations S1 and S2 are repeated until reception of a stop instruction in operation S3 (S3 of FIG. 12A).

In the management server process of FIG. 12B, the management server 50 checks whether packet degradation detection information has been transmitted from the monitoring device 48-1 or 48-2 in operation S1 (S1 of FIG. 12B). When it is determined that the packet degradation detection information has been transmitted, the process proceeds to operation S2, and the router information collecting unit 38 collects router information (S2 of FIG. 12B).

The above-described processes of operations S1 and S2 are repeated until reception of a stop instruction in operation S3 (S3 of FIG. 12B).

In the management server process of FIG. 12C, the management server 50 checks whether packet degradation detection information has been transmitted from the monitoring device 48-1 or 48-2 in operation S1 (S1 of FIG. 12C). When it is determined that the packet degradation detection information has been transmitted, the process proceeds to operation S2, and the server information collecting unit 40 executes the server information collecting process (S2 of FIG. 12C).

The above-described processes of operations S1 and S2 are repeated until reception of a stop instruction in operation S3 (S3 of FIG. 12C).

In the management server process of FIG. 12D, the management server 50 checks whether packet degradation detection information has been transmitted from the monitoring device 48-1 or 48-2 in operation S1 (S1 of FIG. 12D). When it is determined that the packet degradation detection information has been transmitted, the process proceeds to operation S2, and the gateway information collecting unit 42 executes the information collecting process (S2 of FIG. 12D).

The above-described processes of operations S1 and S2 are repeated until a stop instruction in operation S3 (S3 of FIG. 12D).

Like the embodiment of FIG. 2, the node search process of operation S2 in FIG. 12A, the router information collecting process of operation S2 in FIG. 12B, and the gateway information collecting process of operation S2 in FIG. 12D correspond to the contents shown in the respective flowcharts of FIGS. 5, 6 and 8.

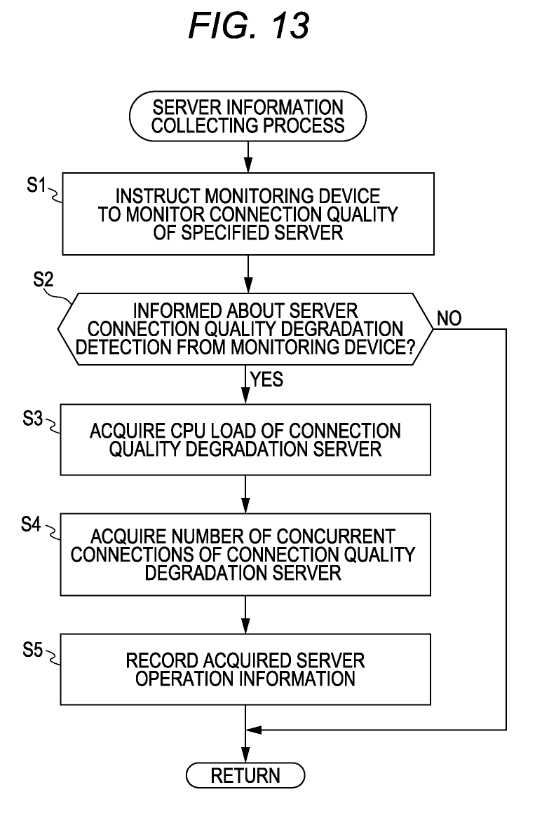

The server information collecting process of operation S2 in FIG. 12C corresponds to the process shown in the flowchart of FIG. 13.

In the server information collecting process of FIG. 13, an instruction for monitoring connection quality of a specified server is issued to a monitoring device (e.g. the monitoring device 48-1) which has detected and reported the degradation of the audio packet in operation S1 (S1 of FIG. 13).

This instruction is determined in operation S1 in the monitoring device process of FIG. 11B (S1 of FIG. 11B), and the connection quality monitoring process for the specified server is performed in operation S2 (S2 of FIG. 11B).

Subsequently, in the server information collecting process shown in FIG. 13, the server 50 checks whether the server connection quality degradation detection information has been transmitted from the monitoring device 48-1 (S2 of FIG. 13).

The process proceeds to operation S3 upon determination of information representing the server connection quality degradation detection, at which the server 50 acquires server operation information of the connection quality degraded server (e.g. the CPU load, the memory usage, the free memory capacity, the free disk space and the disk access count) (S3 of FIG. 13). The server 50 acquires the number of concurrent connection sessions of the connection quality degraded server in operation S4 (S4 of FIG. 13), and records at least one of the acquired server operation information items, of the CPU load, the memory usage or free memory capacity, the free disk space, the disk access count, the number of transmitted or received packets and the number of concurrent connection sessions (S5 of FIG. 13).

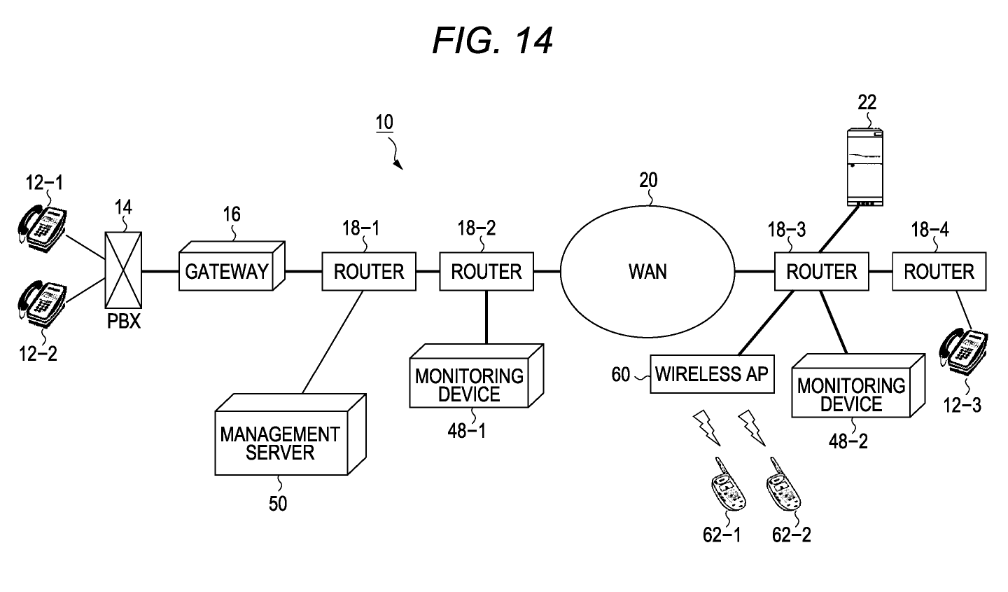

FIG. 14 is an explanatory diagram showing a network fault information collecting system including a wireless LAN access point as a target for collecting information.

In FIG. 14, the IP network 10 has substantially the same configuration as that of FIG. 9. The monitoring devices 48-1 and 48-2 are provided for the IP network 10, and the management server 50 for management is provided separately therefrom.

In addition to the embodiment of FIG. 9, a wireless access point 60 for use in the wireless LAN is connected to the router 18-3, in the IP network 10.

The wireless access point 60 transmits and receives the audio packets between cell phone terminals 62-1 and 62-2, and establishes a call connection between the gateway 16 and the telephone terminal 12-3 arranged in the IP network 10.

When the wireless access point 60 is thus arranged in the IP network 10, the monitoring devices 48-1 and 48-2 detect packet degradation in association with the audio packet in the call between the IP telephone terminal 12-1 and the cell phone terminal 62-1, and inform the management server 50 of the detection. In this case, the management server 50 performs the node search process for searching for the wireless access point 60 in addition to the routers 18-1 to 18-3 as network terminals existing in the network path between the gateway 16 and the cell phone terminal 62-1. Further, the server 50 collects and records, as wireless access point information, operation information regarding the wireless access point 60 and including the CPU load like the gateway 16, the memory usage or free memory capacity, the free disk space or disk access count when an external memory (e.g. a hard disk drive, etc.) is included, the number of transmitted or received packets and the number of concurrent connection sessions.

According to this embodiment, there is provided a program to be executed by a computer including the network fault information collecting device 24 including the monitoring unit 26 and the management server unit 28 of FIG. 2 which are incorporated together. This program corresponds to the contents shown in the flowcharts of FIG. 4 to FIG. 8.

According to this embodiment, there is provided a program to be executed by a computer including the monitoring devices 48-1 and 48-2 and the management server 50 shown in FIG. 10. In this case, the program for the monitoring devices 48-1 and 48-1 corresponds to the contents of the flowchart shown in FIG. 11, while the program to be executed by the computer of the management server 50 corresponds to the contents shown in the flowcharts of FIGS. 12 and 13.

The audio packet in the VoIP protocol is a target protocol to be monitored, and is a packet which is sensitive to the occurrence of the network fault. Other than that, as a packet sensitive to the quality degradation of the packets, any packet in the stream traffic which includes a packet of a video stream may be monitored.

In the above embodiment, other than the configuration of the network fault information collecting device 24 having the monitoring unit 26 and the management server unit 28 of FIG. 2 which are incorporated together, there is provided a configuration having the monitoring devices 48-1 and 48-2 and the management server 50 of FIG. 10 whose functions are separated from each other. This separate-type device configuration is not limited to the embodiment of FIG. 10. The functions of the node search unit 36 provided in the management server 50 may be provided in the monitoring devices 48-1 and 48-2. In the incorporated configuration in FIG. 2, the functions may be set separately between the monitoring device and the management server as needed.

In the above embodiment, the routers, the gateway and the call control server are targets for collecting information in the IP network. However, the present invention is not limited to this. Target nodes and server for packet degradation detection and connection quality degradation may similarly be applied thereto, so as to collect information for discriminating temporary fault.

According to an aspect of an embodiment, when a fault occurs in a network, or when traffic temporarily increases, audio packets (VoIP packet) of an IP telephone is monitored as the most sensitive traffic. Upon detection of quality degradation (such as an increase in the packet delay time, packet loss, etc.), a temporarily occurred network fault or a traffic increase is momentarily detected. The traffic flowing through the router at that moment is measured. Further, load conditions of the SIP server, web server and gateway and operation information regarding the number of concurrently connected clients are measured and collected. As a result, it is possible to efficiently collect fault information for detecting a factor of an intermittent network fault to be easily missed and for detecting a temporary increase in server load.

The device of this invention collects information regarding the routers and server(s) existing in the route between particular terminal units wherein the packet quality degradation has been detected. Thus, there is no need to collect information from the entire network, and it is possible to efficiently collect information from a focused part of the network wherein a fault may possibly have occurred. Therefore, it is possible to minimize the processing burden for collecting information and influence on the network.

The embodiments can be implemented in computing hardware (computing apparatus) and/or software, such as (in a non-limiting example) any computer that can store, retrieve, process and/or output data and/or communicate with other computers. The results produced can be displayed on a display of the computing hardware. A program/software implementing the embodiments may be recorded on computer-readable media comprising computer-readable recording media. The program/software implementing the embodiments may be transmitted over transmission communication media. Examples of the computer-readable recording media include a magnetic recording apparatus, an optical disk, a magneto-optical disk, and/or a semiconductor memory (for example, RAM, ROM, etc.). Examples of the magnetic recording apparatus include a hard disk device (HDD), a flexible disk (FD), and a magnetic tape (MT). Examples of the optical disk include a DVD (Digital Versatile Disc), a DVD-RAM, a CD-ROM (Compact Disc-Read Only Memory), and a CD-R (Recordable)/RW. An example of communication media includes a carrier-wave signal.

Further, according to an aspect of the embodiments, any combinations of the described features, functions and/or operations can be provided.

The many features and advantages of the embodiments are apparent from the detailed specification and, thus, it is intended by the appended claims to cover all such features and advantages of the embodiments that fall within the true spirit and scope thereof. Further, since numerous modifications and changes will readily occur to those skilled in the art, it is not desired to limit the inventive embodiments to the exact construction and operation illustrated and described, and accordingly all suitable modifications and equivalents may be resorted to, falling within the scope thereof.

What is described as optional embodiment is:

(1). A network fault information collecting device arranged in a packet network, comprising:

a quality degradation detecting unit which monitors packets to be regularly transmitted and received in the packet network, and detects quality degradation of the packet;

a node search unit which searches for nodes on a path between transmission and reception terminals for the packet, upon detection of the quality degradation of the packets in the quality degradation detecting unit; and

an information collecting unit which issues an information collecting packet for each terminal searched by the nodes search unit, and collects and records terminal information.

(2). The fault information collecting device according to optional embodiment (1), wherein

the quality degradation detecting unit monitors audio packets using a VoIP protocol, determines that a delay time of the audio packets increases or that the audio packets are lost, thereby detecting the network quality degradation.

(3). The fault information collecting device according to optional embodiment (1), wherein

the node search unit includes at least one of:

a first node search unit which searches for nodes on the path between the transmission and reception terminals, by issuing a terminal search command to the transmission and reception terminals for the packet; and

a second node search unit which searches for nodes on the path between the transmission and reception terminals based on network topology information registered in advance.

(4). The fault information collecting device according to optional embodiment (1), wherein

the information collecting unit issues an SNMP command a plurality of times at a predetermined time interval toward each node searched by the node search unit and acquires the number of accumulated packets so as to obtain traffic flow.

(5). The fault information collecting device according to optional embodiment (4), wherein

the traffic flow is the number of packets per unit time which is obtained by dividing a sum of differences of adjacent packets within time-series numbers of accumulated packets acquired from the node by a value obtained by multiplying a value reduced by 1 from the number of times the command is issued by a predetermined time interval.

(6). The fault information collecting device according to optional embodiment (1), wherein

the quality degradation detecting unit measures a packet transmission/reception interval between a particular server and an arbitrary terminal arranged in the packet network, and detects degradation of connection quality in the server, and

the information collecting unit collects and records operation information from the server, upon detection of the degradation of the connection quality in the quality degradation detecting unit.

(7). The fault information collecting device according to optional embodiment (1), wherein

the quality degradation detecting unit further monitors a packet transmission/reception interval time in relation to a request and a response between the server and an arbitrary terminal, and determines that the packet transmission/reception interval exceeds a predetermined threshold value or that the packet transmission/reception interval jitters over a predetermined fluctuation width, so as to detect degradation of the connection quality.

(8). The fault information collecting device according to optional embodiment (6), wherein

the server is a SIP (Session Initiation Protocol) server, and

the quality degradation detecting unit measures, as the packet transmission/reception interval, a response time since transmission of a SIP signaling packet to the SIP server until reception of its response packet, so as to detect degradation of the connection quality.

(9). The fault information collecting device according to optional embodiment (6), wherein

the information collecting unit collects, as the operation information, at least one of CPU load of the server, memory usage or free memory capacity, a free disk space, a disk access count, the number of transmitted or received packets and the number of concurrent connection sessions.

(10). The fault information collecting device according to optional embodiment (1), wherein

the information collecting unit collects and records operation information including at least one of CPU load, memory usage or free memory capacity, a free disk space or disk access count, the number of transmitted or received packets and the number of concurrent connection sessions, from a device which can concurrently realize a plurality of sessions arranged in the packet network, upon detection of quality degradation of the packet in the quality degradation detecting unit.

(11). The fault information collecting device according to optional embodiment (10), wherein

the device which can concurrently realize the plurality of sessions arranged in the packet network is an access point of a gateway and a wireless LAN.

(12). A network fault information collecting system including one or a plurality of monitoring devices arranged in a packet network and a management server which manages the one or the plurality of monitoring devices, wherein

the monitoring device includes a quality degradation detecting unit which monitors a packet regularly transmitted and received in the packet network, and detects quality degradation of the packet, and

the management server includes:

a node search unit which searches for nodes on a path between transmission and reception terminals for the packet, upon detection of the quality degradation of the packet in the quality degradation detecting unit; and

an information collecting unit which issues a test command toward each node searched by the node search unit, and collects and records node information.

(13). The fault information collecting system according to optional embodiment (12), wherein

the quality degradation detecting unit of the monitoring device monitors audio packets using VoIP protocol, and determines that a delay time of the audio packets increases or that the audio packets are lost, so as to detect the network quality degradation.

(14). The fault information collecting system according to optional embodiment (13), wherein

the node search unit of the management server includes at least one of:

a first node search unit which searches for nodes on a path between the transmission and reception terminals by issuing a node search command to the transmission and reception terminals of the packet; and

a second node search unit which searches for nodes on the path between the transmission and reception terminals based on network topology information registered in advance.

(15). The fault information collecting system according to optional embodiment (12), wherein

the information collecting unit of the management server issues an SNMP command a plurality of times at a predetermined time interval toward each node searched by the node search unit, and acquires the number of accumulated packets so as to obtain traffic flow.

(16). The fault information collecting system according to optional embodiment (15), wherein

the traffic flow is the number of packets per unit time which is obtained by dividing a sum of differences of adjacent packets within time-series numbers of accumulated packets acquired from the node by a value obtained by multiplying a value reduced by 1 from the number of times the command is issued by a predetermined time interval.

(17). The fault information collecting system according to optional embodiment (12), wherein

the information collecting unit of the management server detects the same node on a plurality of paths, and issues one test command so as to avoid collection of duplicate node information, when issuing the test command for the node on the plurality of paths that has received detection information representing the network quality degradation from the plurality of monitoring devices.

(18). The fault information collecting system according to optional embodiment (12), wherein

the quality degradation detecting unit of the monitoring device further measures a packet transmission/reception interval between a particular server and an arbitrary terminal arranged in the packet network, and detects degradation of connection quality in the server, and

the information collecting unit of the management server collects and records operation information from the server, upon detection of degradation of the connection quality in the quality degradation detecting unit.

(19). The fault information collecting system according to optional embodiment (18), wherein

the server is a SIP (Session Initiation Protocol) server, and

the quality degradation detecting unit of the monitoring device measures, as the packet transmission/reception time, a response time since transmission of a SIP signaling packet to the SIP server until reception of its response packet.

(20). The fault information collecting system according to optional embodiment (18), wherein

the information collecting unit of the management server collects, as the operation information, at least one of CPU load of the server, memory usage or free memory capacity, a free disk space, a disk access count, the number of transmitted or received packets and the number of concurrent connection sessions.

(21). The fault information collecting system according to optional embodiment (12), wherein

the information collecting unit of the management server collects and records operation information including at least one of CPU load, memory usage or free memory capacity, a free disk space, a disk access count, the number of transmitted or received packets and the number of concurrent connection sessions from a device which can concurrently realize a plurality of sessions arranged in the packet network, upon detection of quality degradation of the packet in the quality degradation detecting unit of the monitoring device.

(22). The fault information collecting system according to optional embodiment (21), wherein

the device which can concurrently realize a plurality of sessions arranged in the packet network is an access point of a gateway and a wireless LAN, and

the information collecting unit of the management server collects and records the operation information while avoiding its duplication from the gateway and the access point, upon detection of quality degradation of the packet in the plurality of monitoring devices.

(23). A network fault information collecting method for use in a network fault information collecting device arranged in a packet network, the method comprising:

a quality degradation detecting operation of monitoring a packet which is regularly transmitted and received in the packet network, and detecting quality degradation of the packet;

a node search operation of searching for a node as nodes on a path between transmission and reception terminals of the packet, upon detection of the quality degradation of the packet in the quality degradation detecting operation; and

an information collecting operation of collecting and recording node information by issuing an information collecting packet to each node searched in the node search operation.

(24). The fault information collecting method according to optional embodiment (23), wherein

the quality degradation detecting operation includes monitoring audio packets using VoIP protocol and discriminating that a delay time of the audio packets increases or that the audio packets are lost so as to detect quality degradation.

(25). The fault information collecting method according to optional embodiment (23), wherein

the node search operation includes:

a first node search operation of searching for an address of each node on a path between the transmission and reception terminals by transmitting a node search packet to the transmission and reception terminals of the packet; and

a second node search operation of searching for an address of each node on a path between the transmission and reception terminals based on network topology information registered in advance.

(26). The fault information collecting method according to optional embodiment (23), wherein

the information collecting operation includes obtaining traffic flow based on the number of accumulated packets included in node management information acquired by issuing an SNMP packet a plurality of times at a predetermined time interval to each node searched in the node search operation.

(27). The fault information collecting method according to optional embodiment (23), wherein

the traffic flow is the number of packets per unit time which is obtained by dividing a sum of differences of adjacent packets within time-series numbers of accumulated packets acquired from the node by a value obtained by multiplying a value reduced by 1 from the number of times the command is issued by a predetermined time interval.

(28). The fault information collecting method according to optional embodiment (23), wherein

the quality degradation detecting operation includes measuring a packet transmission/reception interval between a particular server and an arbitrary terminal arranged in the packet network and detecting degradation of connection quality in the server, upon detection of degradation of the packet quality, and

the information collecting operation includes collecting and recording operation information from the server, upon detection of the degradation of the connection quality in the quality degradation detecting operation.

(29). The fault information collecting method according to optional embodiment (28), wherein

the quality degradation detecting operation includes measuring a packet transmission/reception interval since transmission of an information request packet to the server from the terminal until reception of a response packet, and discriminating that the packet transmission/reception interval exceeds a predetermined threshold value or that the packet transmission/reception interval jitters over a predetermined fluctuation width, so as to detect degradation of the connection quality.

(30). The fault information collecting method according to optional embodiment (28), wherein

the server is a SIP server, and

the quality degradation detecting operation includes measuring, as the packet transmission/reception interval, a response time since transmission of a SIP signaling packet from the terminal to the SIP server until reception of its response packet, so as to detect degradation of the connection quality.

(31). The fault information collecting method according to optional embodiment (28), wherein

the information collecting operation includes collecting, as the operation information, at least one of CPU load of the server, memory usage or free memory capacity, a free disk space, a disk access count, the number of transmitted or received packets and the number of concurrent connection sessions.

(32). The fault information collecting method according to optional embodiment (23), wherein

the information collecting operation includes collecting and recording operation information including at least one of CPU load, memory usage or free memory capacity, a free disk space or disk access count, the number of ransmitted or received packets and the number of concurrent connection sessions, from a node which can connect a plurality of networks arranged in the packet network and concurrently realize a plurality of sessions, upon detection of quality degradation of the packet in the quality degradation detecting operation.

(33). The fault information collecting method according to optional embodiment (32), wherein

the node is an access point of a gateway or a wireless LAN.

(34). A program for causing a computer of a network fault information collecting device arranged in a packet network to function as:

a quality degradation detecting unit which monitors a packet regularly transmitted and received in the packet network, and detects quality degradation of the packet;

a node search unit which searches for a node as nodes on a path between transmission and reception terminals for the packet, upon detection of the quality degradation of the packet in the quality degradation detecting unit; and

an information collecting unit which issues an information collecting packet toward each node searched by the node search unit, and collects and records node information.

(35). The program according to optional embodiment (34), wherein

the quality degradation detecting unit monitors audio packets using VoIP, and

determines that a delay time of the audio packets increases or that the audio packets are lost, so as to detect the quality degradation.

(36). The program according to optional embodiment (34), wherein

the node search unit includes:

a first node search unit which searches for an address of each node on a path between the transmission and reception terminals by transmitting a node search packet to the transmission and reception terminals for the packet; and

a second node search unit which searches for an address of each node on the path between the transmission and reception terminals based on network topology information registered in advance.

(37). The program according to optional embodiment (34), wherein

the information collecting unit issues an SNMP packet a plurality of times at a predetermined time interval toward each node searched by the node search unit, and obtains traffic flow based on the number of accumulated packets included in acquired node management information.

(38). The program according to optional embodiment (37), wherein

the traffic flow is the number of packets per unit time which is obtained by dividing a sum of differences of adjacent packets within time-series numbers of accumulated packets acquired from the node by a value obtained by multiplying a value reduced by 1 from the number of times the command is issued by a predetermined time interval.

(39). The program according to optional embodiment (34), wherein

the quality degradation detecting unit measures a packet transmission/reception interval between a particular server and an arbitrary terminal arranged in the packet network, and detects degradation of connection quality in the server, upon detection of degradation of the packet quality, and

the information collecting unit collects and records operation information from the server, upon detection of degradation of the connection quality in the quality degradation detecting unit.

(40). The program according to optional embodiment (39), wherein

the quality degradation detecting unit monitors a packet transmission/reception interval since transmission of an information request packet to the server from the terminal until reception of a response packet, and determines that the packet transmission/reception interval exceeds a predetermined threshold value or that the packet transmission/reception interval jitters over a predetermined fluctuation width, so as to detect degradation of the connection quality.

(41). The program according to optional embodiment (39), wherein

the server is a SIP server, and

the quality degradation detecting unit measures, as the packet transmission/reception interval, a response time since transmission of a SIP signaling packet from the terminal to the SIP server until reception of its response packet, so as to detect degradation of the connection quality.

(42). The program according to optional embodiment (39), wherein

the information collecting unit collects, as the operation information, at least one of CPU load of the server, memory usage or free memory capacity, a free disk space, a disk access count, the number of transmitted or received packets and the number of concurrent connection sessions.

(43). The program according to optional embodiment (34), wherein

the information collecting unit collects and records operation information including at least one of CPU load, memory usage or free memory capacity, a free disk space or disk access count, the number of transmitted or received packets and the number of concurrent connection sessions, from a node which can connect a plurality of networks arranged in the packet network and concurrently realize a plurality of sessions, upon detection of quality degradation of the packet in the quality degradation detecting unit.

(44). The program according to optional embodiment (34), wherein

the node is an access point of a gateway or a wireless LAN.

Although a few preferred embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A network fault information collecting device arranged in a packet network, comprising:
a quality degradation detecting unit which monitors packets to be regularly transmitted and received in the packet network, and detects quality degradation of the packet;
a node search unit which searches for nodes on a path between transmission and reception terminals for the packet, upon detection of the quality degradation of the packets in the quality degradation detecting unit; and
an information collecting unit which issues an information collecting packet for each terminal searched by the node search unit, and collects and records terminal information.

2. The fault information collecting device according to claim 1, wherein
the quality degradation detecting unit monitors audio packets using a VoIP protocol, determines that a delay time of the audio packets increases or that the audio packets are lost, thereby detecting the quality degradation.

3. The fault information collecting device according to claim 1, wherein
the node search unit includes at least one of:
a first node search unit which searches for nodes on the path between the transmission and reception terminals, by issuing a terminal search command to the transmission and reception terminals for the packet; and
a second node search unit which searches for nodes on the path between the transmission and reception terminals based on network topology information registered in advance.

4. The fault information collecting device according to claim 1, wherein
the information collecting unit issues an SNMP command a plurality of times at a predetermined time interval toward each node searched by the node search unit and acquires the number of accumulated packets so as to obtain traffic flow.

5. The fault information collecting device according to claim 4, wherein
the traffic flow is the number of packets per unit time which is obtained by dividing a sum of differences of adjacent packets within time-series numbers of accumulated packets acquired from the node by a value obtained by multiplying a value reduced by 1 from the number of times the command is issued by a predetermined time interval.

6. The fault information collecting device according to claim 1, wherein
the quality degradation detecting unit measures a packet transmission/reception interval between a particular server and an arbitrary terminal arranged in the packet network, and detects degradation of connection quality in the server, and
the information collecting unit collects and records operation information from the server, upon detection of the degradation of the connection quality in the quality degradation detecting unit.

7. The fault information collecting device according to claim 1, wherein
the quality degradation detecting unit further monitors a packet transmission/reception
interval in relation to a request and a response between the server and an arbitrary terminal, and determines that the packet transmission/reception interval exceeds a predetermined threshold value or that the packet transmission/reception interval jitters over a predetermined fluctuation width, so as to detect degradation of the connection quality.

8. The fault information collecting device according to claim 6, wherein
the server is a SIP (Session Initiation Protocol) server, and
the quality degradation detecting unit measures, as the packet transmission/reception interval, a response time since transmission of a SIP signaling packet to the SIP server until reception of its response packet, so as to detect degradation of the connection quality.

9. The fault information collecting device according to claim 6, wherein
the information collecting unit collects, as the operation information, at least one of CPU load of the server, memory usage or free memory capacity, a free disk space, a disk access count, the number of transmitted or received packets and the number of concurrent connection sessions.

10. The fault information collecting device according to claim 1, wherein
the information collecting unit collects and records operation information including at least one of CPU load, memory usage or free memory capacity, a free disk space or disk access count, the number of transmitted or received packets and the number of concurrent connection sessions, from a device which can concurrently realize a plurality of sessions arranged in the packet network, upon detection of quality degradation of the packet in the quality degradation detecting unit.

11. The fault information collecting device according to claim 10, wherein
the device which can concurrently realize the plurality of sessions arranged in the packet network is an access point of a gateway and a wireless LAN.

12. A network fault information collecting system including one or a plurality of monitoring devices arranged in a packet network and a management server which manages the one or the plurality of monitoring devices, wherein
the monitoring device includes a quality degradation detecting unit which monitors a packet regularly transmitted and received in the packet network, and detects quality degradation of the packet, and
the management server includes:
a node search unit which searches for nodes on a path between transmission and reception terminals for the packet, upon detection of the quality degradation of the packet in the quality degradation detecting unit; and
an information collecting unit which issues a test command toward each node searched by the node search unit, and collects and records node information.

13. The fault information collecting system according to claim 12, wherein
the quality degradation detecting unit of the monitoring device monitors audio packets
using VoIP protocol, and determines that a delay time of the audio packets increases or that the audio packets are lost, so as to detect the quality degradation.

14. The fault information collecting system according to claim 13, wherein
the node search unit of the management server includes at least one of:
a first node search unit which searches for nodes on a path between the transmission and reception terminals by issuing a node search command to the transmission and reception terminals of the packet; and
a second node search unit which searches for nodes on the path between the transmission and reception terminals based on network topology information registered in advance.

15. The fault information collecting system according to claim 12, wherein
the information collecting unit of the management server issues an SNMP command a plurality of times at a predetermined time interval toward each node searched by the node search unit, and acquires the number of accumulated packets so as to obtain traffic flow.

16. The fault information collecting system according to claim 15, wherein
the traffic flow is the number of packets per unit time which is obtained by dividing a sum of differences of adjacent packets within time-series numbers of accumulated packets acquired from the node by a value obtained by multiplying a value reduced by 1 from the number of times the command is issued by a predetermined time interval.

17. The fault information collecting system according to claim 12, wherein
the information collecting unit of the management server detects the same node on a plurality of paths, and issues one test command so as to avoid collection of duplicate node information, when issuing the test command for the node on the plurality of paths that has received detection information representing the quality degradation from the plurality of monitoring devices.

18. The fault information collecting system according to claim 12, wherein
the quality degradation detecting unit of the monitoring device further measures a packet transmission/reception interval between a particular server and an arbitrary terminal arranged in the packet network, and detects degradation of connection quality in the server, and
the information collecting unit of the management server collects and records operation information from the server, upon detection of degradation of the connection quality in the quality degradation detecting unit.

19. The fault information collecting system according to claim 18, wherein
the server is a SIP (Session Initiation Protocol) server, and
the quality degradation detecting unit of the monitoring device measures, as the packet transmission/reception time, a response time since transmission of a SIP signaling packet to the SIP server until reception of its response packet.

20. A network fault information collecting method for use in a network fault information collecting device arranged in a packet network, the method comprising:
a quality degradation detecting operation of monitoring packets which is regularly transmitted and received in the packet network, and detecting quality degradation of the packet;
a node search operation of searching for a node as nodes on a path between transmission and reception terminals of the packet, upon detection of the quality degradation of the packets in the quality degradation detecting operation; and
an information collecting operation of collecting and recording node information by issuing an information collecting packet to each node searched in the node search operation.
